(19) United States
(12) Patent Application Publication
(10) Pub. No.: US 2026/0277282 A1
(43) Pub. Date: Sep. 17, 2026

(54) HARD DISK DRIVE HOLDING DEVICE, METHOD FOR MOUNTING A HARD DISK DRIVE TO THE SAME, AND METHOD FOR DISASSEMBLING A HARD DISK DRIVE FROM THE SAME

(71) Applicant: Jabi Circuit (Singapore) Pte, Ltd., Singapore (SG)

(72) Inventors: Chen-Lu Fan, Taichung City (TW); Yu-Ming Lin, Taichung City (TW); Hsun-Wei Fan, Taichung City (TW)

(73) Assignee: Jabi Circuit (Singapore) Pte, Ltd., Singapore (SG)

(21) Appl. No.: 19/341,574

(22) Filed: Sep. 26, 2025

(30) Foreign Application Priority Data
Mar. 13, 2025 (CN) 202520442095.6

(51) Int. Cl. G06F 1/186

(52) U.S. Cl. CPC G06F 1/186

(57) ABSTRACT

A hard disk drive holding device is adapted for holding a hard disk drive. The hard disk drive has a front face, a rear face opposite to the front face, two side faces, and two apertures formed respectively on the side faces. The hard disk drive holding device includes a support frame and a holding member. The support frame includes a front part adapted to abut against the front face, and two side arms connected respectively to two ends of the front part. The holding member is made of flexible material, and includes a connecting part, and two holding arms extending respectively from two ends of the connecting part and connected respectively to rear ends of the two side arms distal from the front part. Each of the holding arms has a projecting portion adapted to engage a respective one of the apertures.

### CROSS-REFERENCE TO RELATED APPLICATION

This application claims priority to Chinese Utility Model Patent Application No. 202520442095.6, filed on Mar. 13, 2025, the entire disclosure of which is incorporated by reference herein.

### FIELD

The disclosure relates to a holding device, and more particularly to a hard disk drive holding device.

### BACKGROUND

A conventional hard disk drive holding device is adapted for holding a hard disk drive and includes a support frame and two fastening members. The hard disk drive includes two apertures that are formed on the side faces thereof. The support frame includes a front part and two side arms that are connected respectively to two ends of the front part. The two fastening members may penetrate through the side arms and extend into the apertures, respectively, in order to hold the hard disk drive. The two fastening members are screws, while the apertures are threaded on the inside. Such a holding means is time consuming during assembly, inconvenient to operate, and has a risk of screw loss. Improvement is needed.

### SUMMARY

Therefore, an object of the disclosure is to provide a hard disk drive holding device that can alleviate at least one of the drawbacks of the prior art.

According to the disclosure, a hard disk drive holding device adapted for holding a hard disk drive is provided. The hard disk drive has a front face, a rear face that is opposite to the front face, two side faces, two apertures that are formed respectively on the side faces, and a guiding hole that is formed on the front face. The hard disk drive holding device includes a support frame and a holding member. The support frame includes a front part that is adapted to abut against the front face, two side arms that are connected respectively to two ends of the front part, and a guiding part that is formed on the front part and that is adapted to extend into the guiding hole. The holding member is made of a flexible material, and includes a connecting part and two holding arms that extend respectively from two ends of the connecting part and that are connected respectively to rear ends of the two side arms distal from the front part. Each of the holding arms has a projecting portion that is adapted to engage a respective one of the apertures.

Another object of the disclosure is to provide a method for mounting a hard disk drive to the abovementioned hard disk drive holding device.

According to the disclosure, the method includes the steps of:

(a) providing the abovementioned hard disk drive;

(b) placing the hard disk drive in a manner in which the guiding hole of the hard disk drive is aligned with the guiding part of the hard disk drive holding device;

(c) pushing the hard disk drive toward the front part such that the guiding part extend into the guiding hole); and

(d) pushing the hard disk drive to engage respectively the projecting portions of the holding arms of the hard disk drive holding device with two apertures of the hard disk drive so that the hard disk drive is firmly surrounded and held by the support frame and the holding member.

Another object of the disclosure is to provide a method for disassembling a hard disk drive from the abovementioned hard disk drive holding device.

According to the disclosure, the method includes the steps of:

(a) pressing on the operating portions of the hard disk drive holding device and pushing the hard disk drive to move the projecting portions of the holding arms out of the two apertures; and

pulling the hard disk drive in a direction away from the front part of the hard disk drive holding device to move the guiding part out of the guiding hole.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an embodiment of a hard disk drive holding device holding a hard disk drive according to the disclosure.

FIG. 2 is an exploded perspective view illustrating the embodiment and the hard disk drive.

FIG. 3 is a fragmentary perspective view illustrating the embodiment.

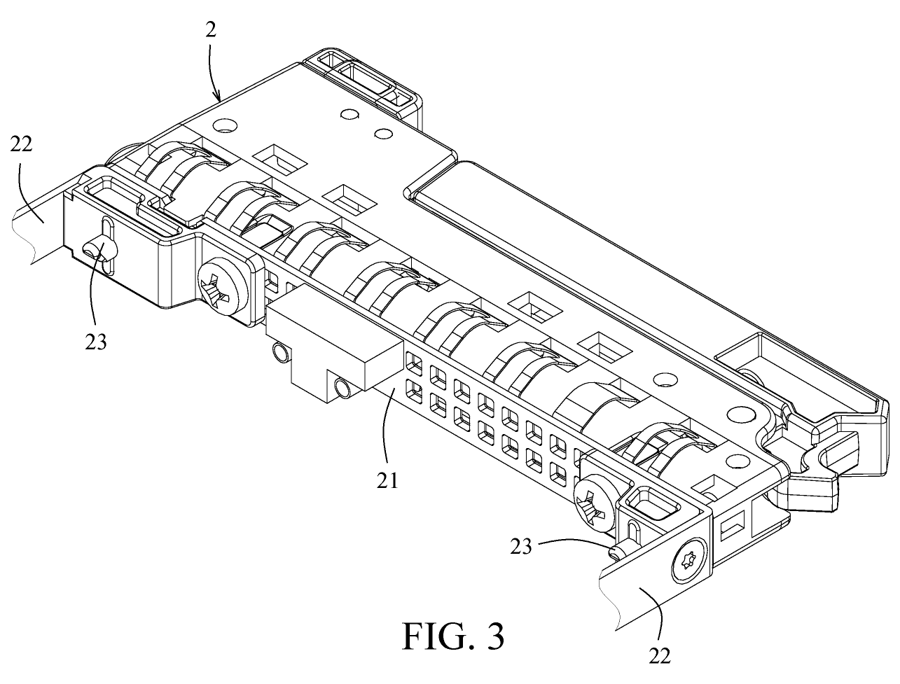

FIG. 4 is a perspective view illustrating the assembly procedure of mounting the hard disk drive to the hard disk drive holding device according to the disclosure.

FIG. 5 is another perspective view illustrating the assembly procedure of mounting the hard disk drive to the hard disk drive holding device according to the disclosure.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

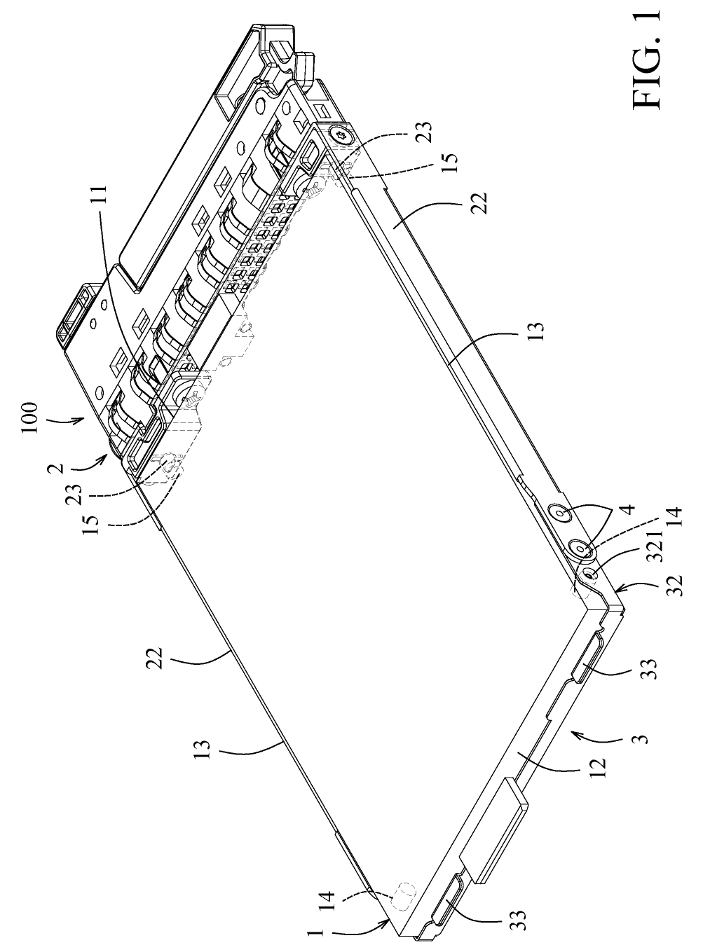

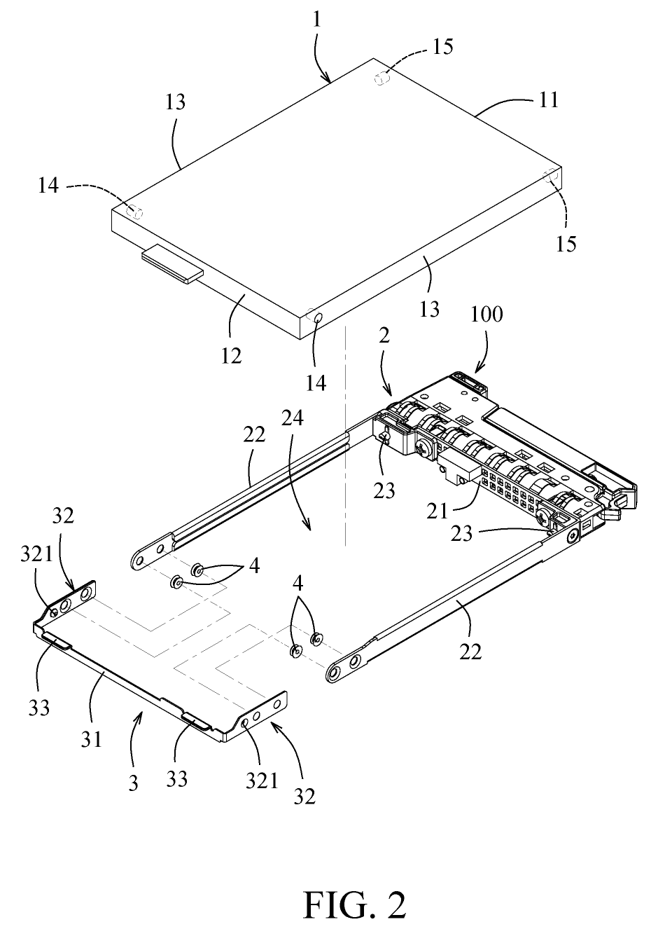

Referring to FIGS. 1 and 2, an embodiment of a hard disk drive holding device 100 according to the disclosure that is adapted for holding a hard disk drive 1 is illustrated. The hard disk drive 1 has a front face 11, a rear face 12 that is opposite to the front face 11, two side faces 13, two apertures 14 that are formed respectively on the side faces 13, and two guiding holes 15 that are formed on the front face 11. Note that the apertures 14 and the guiding holes 15 are built-in threaded holes of the hard disk drive 1 and are in standard configuration. The hard disk drive holding device 100 includes a support frame 2, a holding member 3, and four fastening members 4.

Referring to FIGS. 1 - 3, the support frame 2 is made of galvanized steel sheet and includes a front part 21 that is adapted to abut against the front face 11, two side arms 22 that are connected respectively to two ends of the front part 21, and two guiding parts 23 that are formed on the front part 21 and that are adapted to extend respectively into the two guiding holes 15. The support frame 2 is substantially U-shaped, and the front part 21 and the two side arms 22 collaboratively form a receiving space 24 that is adapted for retaining the hard disk drive 1. Each of the two side arms 22 is substantially in the shape of an elongated thin plate. The number of the guiding part 23 is not limited to two. In other embodiments, at least one guiding part 23 is provided and the number thereof is adjustable.

The holding member 3 is made of a flexible material. In this embodiment, the holding member 3 may be integrally made of stainless steel, which is flexible, but is not limited thereto. The holding member 3 has a flexibility higher than that of the support frame 2. The holding member 3 includes a connecting part 31, two holding arms 32 that extend respectively from two ends of the connecting part 31 and that are connected respectively to rear ends of the two side arms 22 distal from the front part 21, and two operating parts 33 that extend from the connecting part 31 in a direction away from the front part 21 of the support frame 2. Each of the two holding arms 32 has a projecting portion 321 that is adapted to engage a respective one of the apertures 14 formed on the side faces 13. The projecting portion 321 of each of the holding arms 32 is disposed between a corresponding one of the fastening members 4 and the connecting part 31. The projecting portion 321 of each of the holding arms 32 is substantially hemispherical in shape, but is not limited thereto. The number of the operating parts 33 is not limited to two. In other embodiments, at least one operating part 33 is provided and the number thereof is adjustable. Each of the fastening members 4 penetrates through a corresponding one of the two side arms 22 and a corresponding one of the two holding arms 32, such that the two holding arms 32 are fastened to the two side arms 22 respectively. In this embodiment, the fastening members 4 are rivets that are substantially disk-shaped, but are not limited thereto. The number of the fastening members 4 are not limited to four. In other embodiments, it may be other numbers, as long as multiple fastening members 4 are provided.

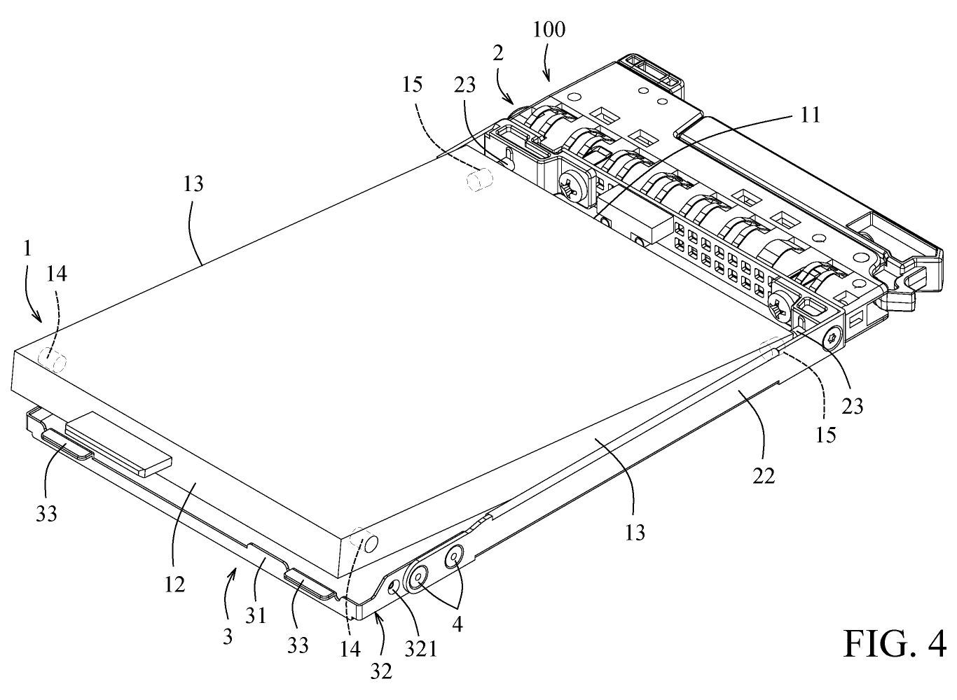

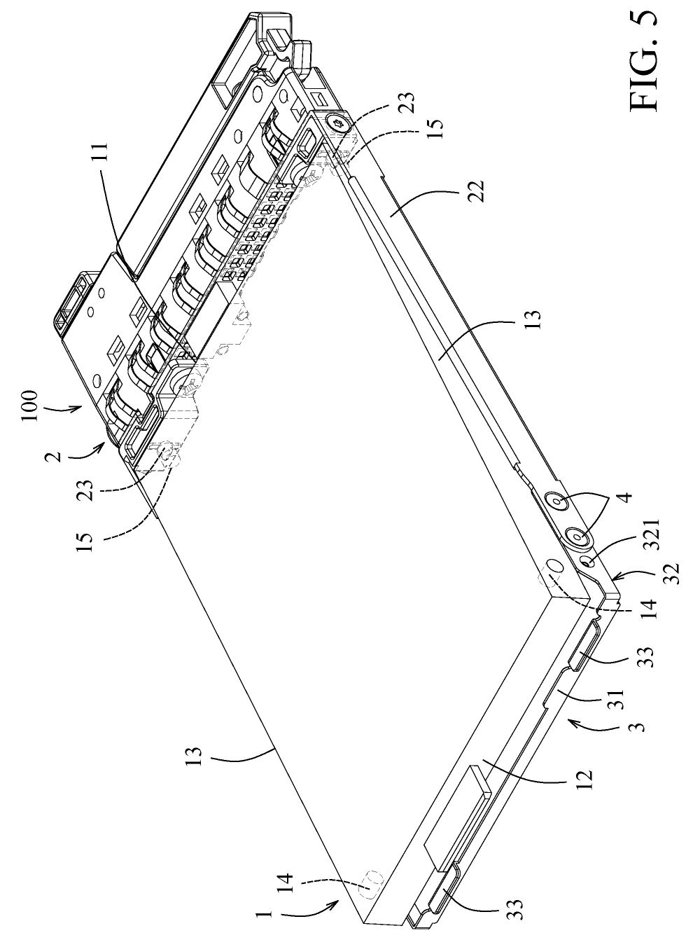

Referring to FIGS. 1, 4 and 5, the assembly procedure of mounting the hard disk drive 1 to the hard disk drive holding device 100 is described in the following. First, the hard disk drive 1 is placed by a user from above the hard disk drive holding device 100 in a manner in which the two guiding holes 15 are aligned with the two guiding parts 23 respectively, as shown in FIG. 4. The hard disk drive 1 is then pushed toward the front part 21 such that the guiding parts 23 extend respectively into the guiding holes 15, as shown in FIG. 5. Finally, the user pushes the hard disk drive 1 downward with their thumb, and their other four fingers abut against the bottom surface of the operating portions 33 of the holding member 3 so that the projecting portions 321 are engaged respectively with the apertures 14 as shown in FIG. 1. In this manner, the hard disk drive 1 can be firmly surrounded and held by the support frame 2 and the holding member 3, and the assembly is completed. The disassembly simply requires reverse operation. With the user’s thumb pressing on the operating portions 33, while the user’s other four fingers press against the bottom surface of the hard disk drive 1 and push the hard disk drive 1 upward, the projecting portions 321 can be moved out of the apertures 14 as shown in FIG. 5. The hard disk drive 1 is then pulled in a direction away from the front part 21 such that the guiding parts 23 are moved out of the guiding holes 15 as shown in FIG. 4. In this manner, the disassembly of the hard disk drive 1 from the hard disk drive holding device 100 is completed. The hard disk drive holding device 100 is convenient to operate, and the time required for the assembly and disassembly is reduced.

According to the above, with the projecting portions 321 of the two holding arms 32 of the holding member 3 being engageable with the apertures 14 of the hard disk drive 1, the user may hold the holding member 3 and the support frame 2 and push the hard disk drive 1 in the manner in which the projecting portions 321 are engaged with the apertures 14 to complete the assembly. In reverse operation, the user may hold the holding member 3 and the support frame 2 and push the hard disk drive 1 in the manner in which the projecting portions 321 are moved out of the apertures 14 to complete the disassembly. The operation is convenient and can reduce the time required for the assembly and disassembly.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A hard disk drive holding device adapted for holding a hard disk drive, the hard disk drive having a front face, a rear face that is opposite to the front face, two side faces, two apertures that are formed respectively on the side faces, and a guiding hole that is formed on the front face, said hard disk drive holding device comprising:
a support frame including a front part that is adapted to abut against the front face, two side arms that are connected respectively to two ends of said front part, and a guiding part that is formed on said front part and that is adapted to extend into the guiding hole; and
a holding member made of a flexible material, said holding member including a connecting part and two holding arms that extend respectively from two ends of said connecting part and that are connected respectively to rear ends of said two side arms distal from said front part, each of said holding arms having a projecting portion that is adapted to engage a respective one of the apertures.

2. The hard disk drive holding device as claimed in claim 1, wherein said holding member further includes an operating part extending from said connecting part in a direction away from said front part of said support frame.

3. The hard disk drive holding device as claimed in claim 1, further comprising a plurality of fastening members that fasten said two holding arms to said two side arms.

4. The hard disk drive holding device as claimed in claim 3, wherein said projecting portion of each of said holding arms is disposed between a corresponding one of said fastening members and said connecting part.

5. The hard disk drive holding device as claimed in claim 1, wherein said projecting portion of each of said holding arms is hemispherical in shape.

6. The hard disk drive holding device as claimed in claim 1, wherein said holding member is integrally made of the flexible material.

7. The hard disk drive holding device as claimed in claim 1, wherein said holding member has a flexibility higher than a flexibility of said support frame.

8. The hard disk drive holding device as claimed in claim 7, wherein said holding member and said support frame are made of stainless steel and galvanized steel sheet, respectively.

9. The hard disk drive holding device as claimed in claim 1, wherein said support frame is substantially U-shaped, said front part and said two side arms collaboratively forming a receiving space that is adapted for retaining the hard disk drive.

10. A method for mounting a hard disk drive to a hard disk drive holding device, comprising the steps of:
(a) providing the hard disk drive holding device as claimed in claim 1;
(b) placing the hard disk drive in a manner in which the guiding hole of the hard disk drive is aligned with the guiding part of the hard disk drive holding device;
(c) pushing the hard disk drive toward the front part such that the guiding part extend into the guiding hole; and
(d) pushing the hard disk drive to engage respectively the projecting portions of the holding arms of the hard disk drive holding device with two apertures of the hard disk drive so that the hard disk drive is firmly surrounded and held by the support frame and the holding member.

11. The method as claimed in claim 10, wherein in step (b), the hard disk drive is placed from above the hard disk drive holding device in the manner in which the guiding hole is aligned with the guiding part of the hard disk drive holding device.

12. The method as claimed in claim 11, wherein in step (d), the hard disk drive is pushed downward to engage the projecting portions of the holding arms respectively with the two apertures.

13. The method as claimed in claim 10, wherein in step (d), the hard disk drive is pushed downward to engage the projecting portions of the holding arms respectively with the two apertures.

14. A method for disassembling a hard disk drive from a hard disk drive holding device as claimed in claim 2, the hard disk drive having a front face, a rear face that is opposite to the front face, two side faces, two apertures that are formed respectively on the side faces, and a guiding hole that is formed on the front face, the guiding part of the hard disk drive holding device extending into the guiding hole of the hard disk drive, the projecting portions of the holding arms of the hard disk drive holding device being engaged respectively with the two apertures of the hard disk drive, said method comprising the steps of:
(a) pressing on the operating portions of the hard disk drive holding device and pushing the hard disk drive to move the projecting portions of the holding arms out of the two apertures; and
(b) pulling the hard disk drive in a direction away from the front part of the hard disk drive holding device to move the guiding part out of the guiding hole.

15. The method as claimed in claim 14, wherein in step (a), the hard disk drive is pushed upward to move the projecting portions of the holding arms out of the two apertures.
